(19) United States
(12) Patent Application Publication
(10) Pub. No.: US 2006/0204920 A1
(43) Pub. Date: Sep. 14, 2006

(54) Dental articulator and method for using same

(75) Inventor: William Costello, East Lansing, MI (US)

Correspondence Address: KNECHTEL DEMEUR & SAMLAN;ATTN: ALAN B. SAMLAN, 222 S. RIVERSIDE, SUITE 1410, CHICAGO, IL, 60606, US

(73) Assignee: Accu-Bite, Inc.

(21) Appl. No.: 11/375,506

(22) Filed: Mar. 14, 2006

Related U.S. Application Data
(60) Provisional application No. 60/661,658, filed on Mar. 14, 2005.

(51) Int. Cl. A61C 11/00; A61C 19/00

(52) U.S. Cl. 433/57; 433/66; 433/74

(57) ABSTRACT

A dental articulator comprising a maxillary tray support member, a mandibular tray support member, and a hinge. The maxillary tray support member and mandibular tray support members are each provided with a locking member. The hinge is separated into an upper hinge arm and a lower hinge arm with each being provided with a key. The combination of the key in the upper and lower hinge arms coupled with the locking member in the maxillary and mandibular tray support members are used to lockingly engage the hinge to these members. The opposed ends of the upper hinge arm and the lower hinge arm are frictionally mountable to one another for forming a hinge joint at each end thereby enabling the rotatable movement of the maxillary and mandibular tray support members for moving the dental articulator from an open and closed position when in use.

### I. FIELD OF THE INVENTION

The present invention relates to dental articulators and, more particularly, to an apparatus and method for making dental models from which bridges, crowns, and other restorative dental work can be produced.

### II. DESCRIPTION OF THE PRIOR ART

Restorative work plays a major part in dental care. Restorative measures such as crowns, bridges, and tooth prosthesis require the use of dental models from which to work. A dental model is typically made by a dentist's first creating a negative impression of the teeth. The negative impression is then filled with a casting material which hardens creating a model of the patient's teeth. In order to work on certain aspects of the model, the casting material must be sawed into usable segments.

Over the years, dental articulator devices have been developed or designed to accomplish this type of restorative work. These include U.S. Pat. Nos. 6,705,864; 6,551,102; 6,511,318; 6,508,646; 6,450,809; 6,499,999; 6,485,302; 6,402,513; 6,402,512; 6,394,804; 6,382,969; 6,318,999; 6,247,927; 6,082,998; 5,957,688; 5,934,901; 5,868.569; 5,800,166; 5,788,489; 5,775,899; 5,769,634; 5,766,007; 5,658,143; 5,622,497; 5,605,456; 5,482,460; 5,466,152; 5,425,636; 5,221,203; 5,076,786; 5,046,949; 5,026,279; 4,865,544; 4,797,097; 4,786,253; 4,734,033; 4,608,016; and 4,496,320.

However, while these above patents may disclose devices related to dental articulators, they do not disclose, teach, or suggest Applicant's unique dental articulator apparatus and method for using this dental articulator.

### III. SUMMARY OF THE INVENTION

The present invention is a dental articulator comprising a maxillary tray support member, a mandibular tray support member, and a hinge. The maxillary tray support member and mandibular tray support members are each provided with a locking member. The hinge is separated into an upper hinge arm and a lower hinge arm with each being provided with a key. The combination of the key in the upper and lower hinge arms coupled with the locking member in the maxillary and mandibular tray support members are used to lockingly engage the hinge to these members. The opposed ends of the upper hinge arm and the lower hinge arm are frictionally mountable to one another for forming a hinge joint at each end thereby enabling the rotatable movement of the maxillary and mandibular tray support members for moving the dental articulator from an open and closed position when in use.

### IV. BRIEF DESCRIPTION OF THE DRAWINGS

The Description of the Preferred Embodiment will be better understood with reference to the following figures:

FIG. 1 is a perspective view of the preferred embodiment of Applicant's inventive dental articulator and, in particular, depicting the dental articulator in the closed position.

FIG. 2 is a perspective view of the dental articulator and, in particular, depicting the dental articulator in the open position.

FIG. 3 is a top plan view of the dental articulator;

FIG. 4 is a front elevational view of the dental articulator;

FIG. 5 is a right side elevational view of the dental articulator. The left side elevational view of the dental articulator is a mirror image of this left side elevational view.

FIG. 6 is a rear end view of the dental articulator.

FIG. 7 is a bottom view of the dental articulator.

FIG. 8 is a perspective view of the dental articulator, with portions removed, depicting the attachment of the hinge arm to a tray support member.

FIG. 9 is a cross-sectional view, taken along line 9-9 of FIG. 2, depicting the attachment of the hinge arm to a tray support member.

FIG. 10 is a perspective view of an alternate embodiment of Applicant's inventive dental articulator and, in particular, depicting the dental articulator in the closed position.

FIG. 11 is a perspective view of the alternate embodiment of the dental articulator and, in particular, depicting the dental articulator in the open position.

FIG. 12 is a top plan view of the alternate embodiment of the dental articulator.

FIG. 13 is a front elevational view of the alternate embodiment of the dental articulator.

FIG. 14 is a right side elevational view of the alternate embodiment of the dental articulator.

FIG. 15 is a left side elevational view of the alternate embodiment of the dental articulator.

FIG. 16 is a rear end view of the alternate embodiment of the dental articulator.

FIG. 17 is a bottom view of the alternate embodiment of the dental articulator.

FIG. 18 is a top plan view of a unique bi-pin design for using with the dental articulator disclosed herein.

FIG. 19 is a side view of the bi-pin design.

FIG. 20 is a bottom view of the bi-pin design.

### V. DETAILED DESCRIPTION OF THE PREFERRED EMBODIMENT

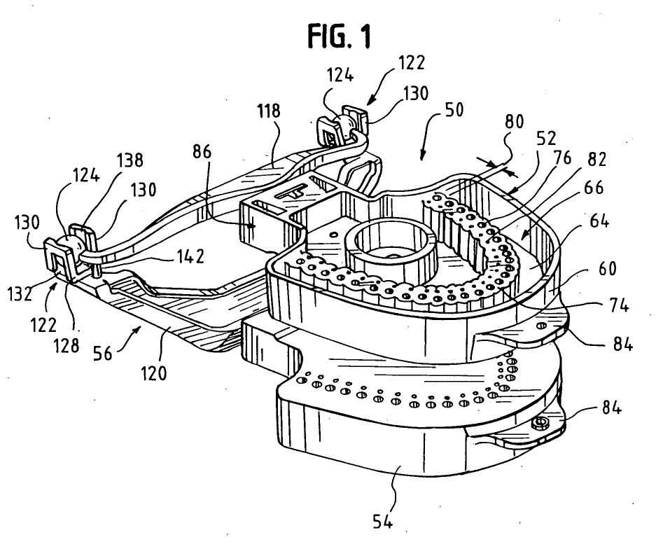

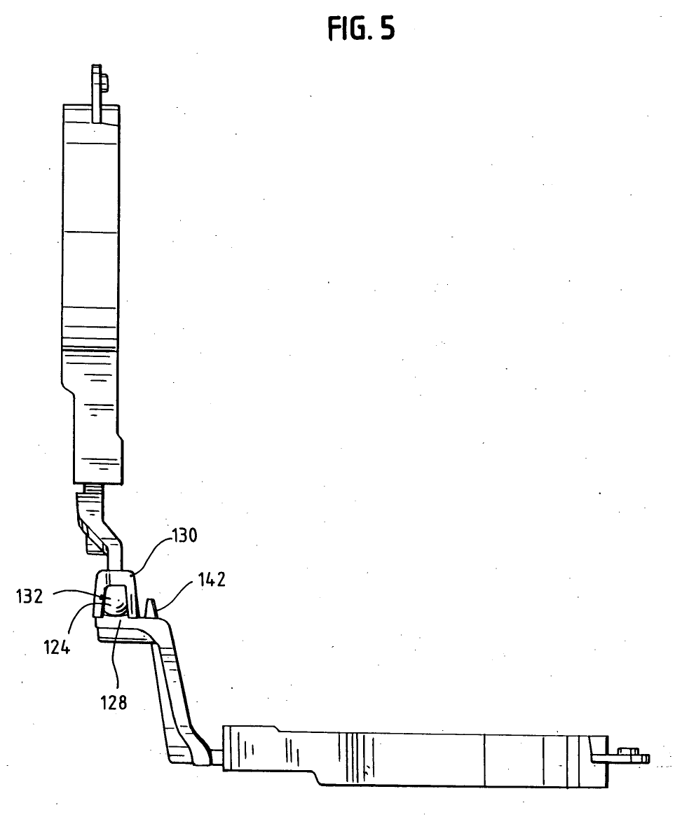

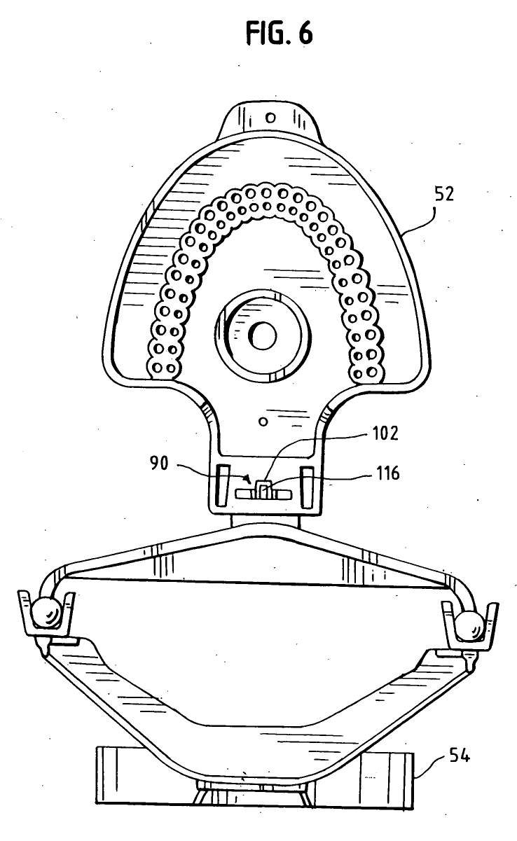

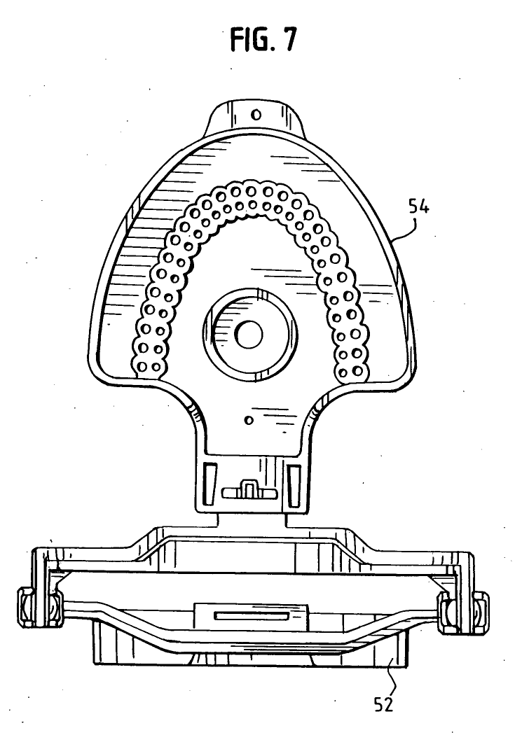

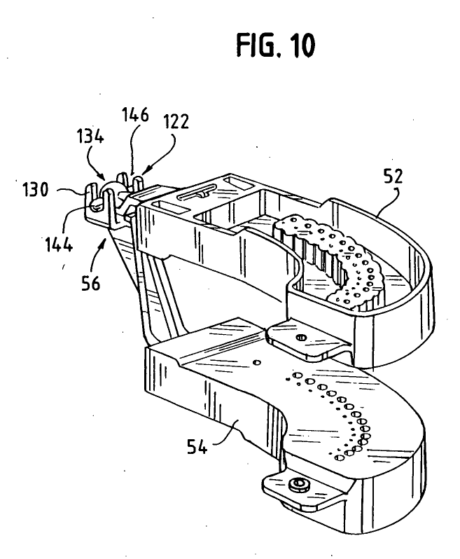

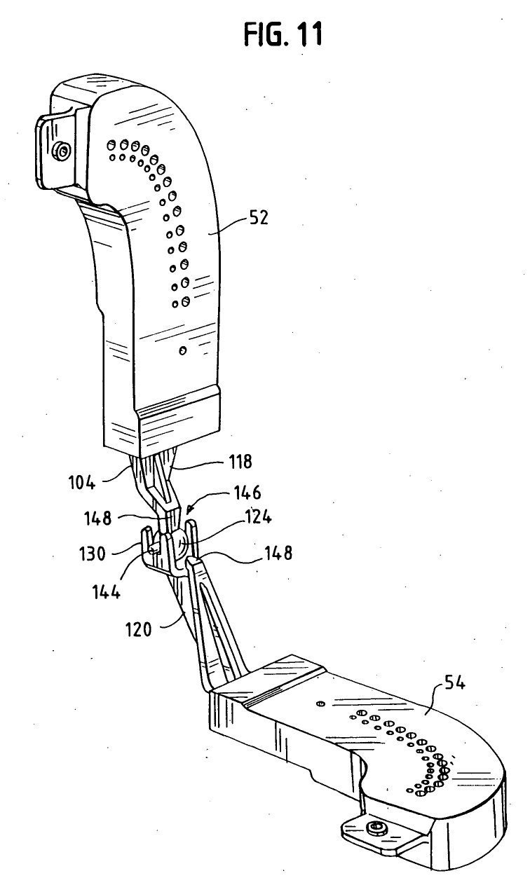

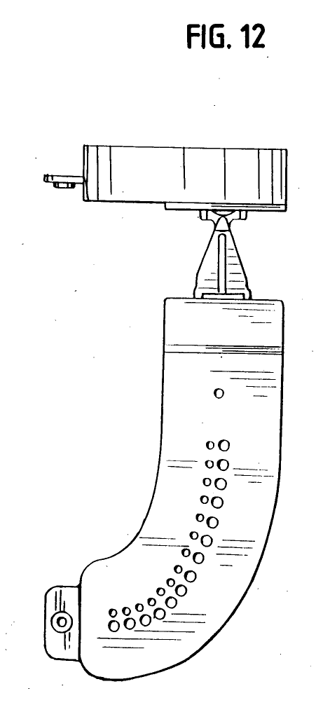

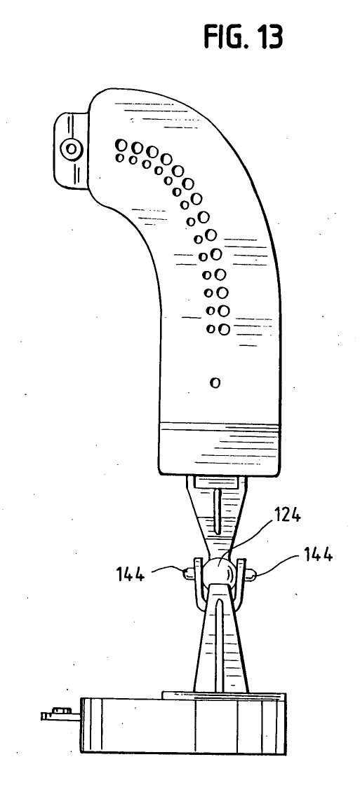

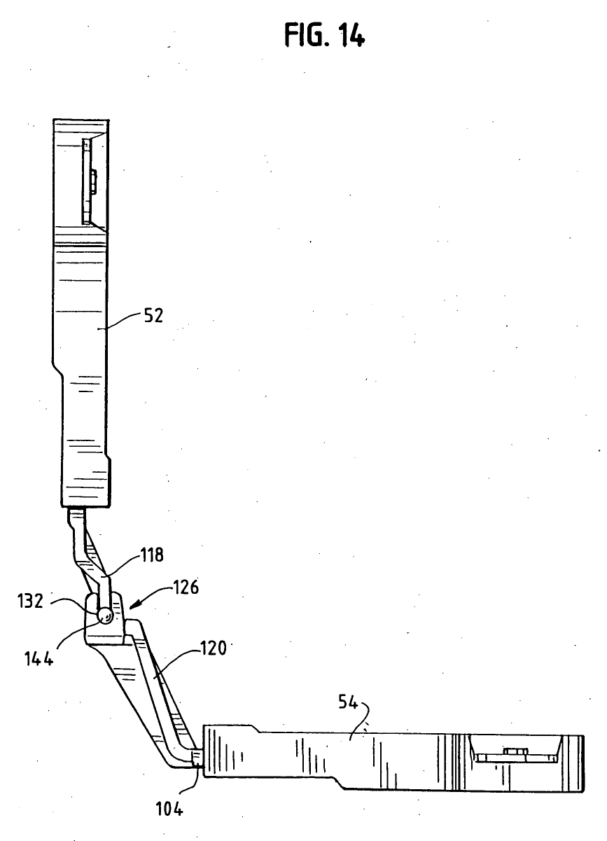

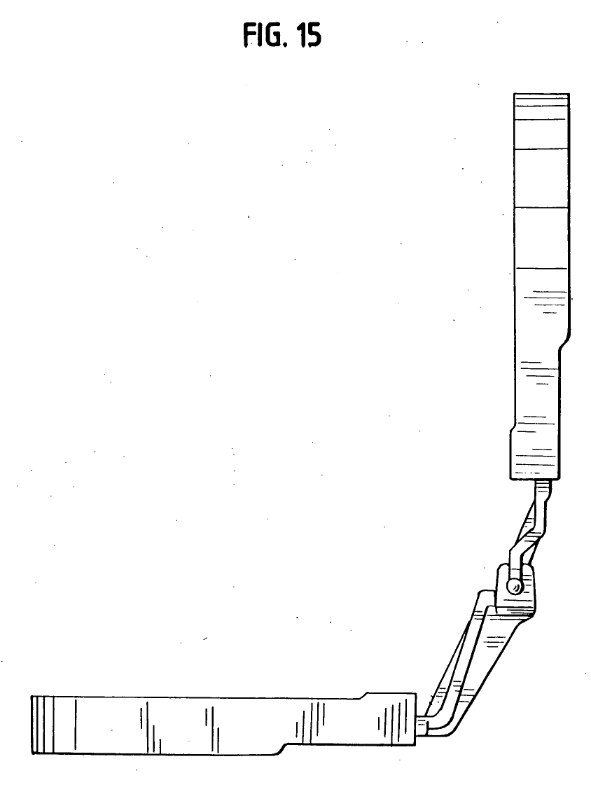

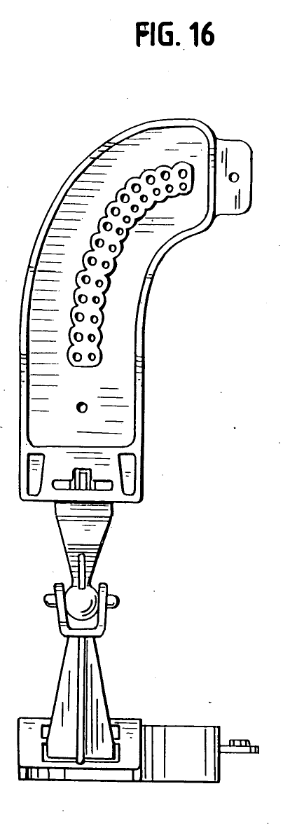

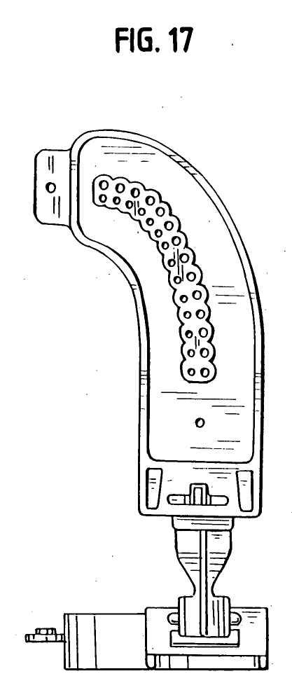

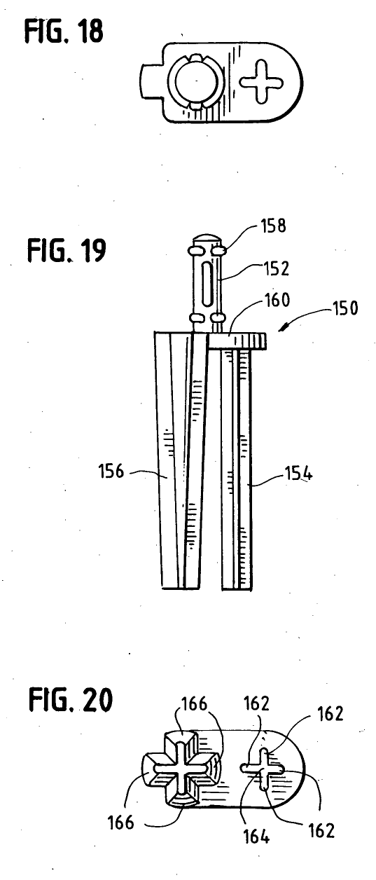

Applicant's dental articulator invention comprises a preferred embodiment as illustrated in FIGS. 1 through 9, an alternate embodiment of the dental articulator as illustrated in FIGS. 10 through 17, and an inventive bi-pin design, as illustrated in FIGS. 18 through 20, that can be used with the dental articulator.

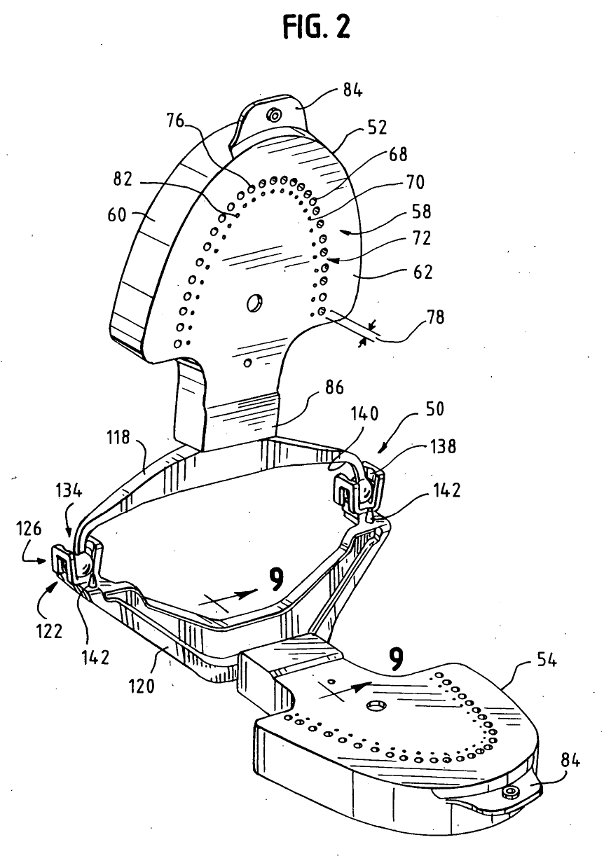

Turning to FIGS. 1 and 2 and beginning with the preferred embodiment, there is illustrated a dental articulator 50 (also referred to as the full arch articulator as it is in the shape of a full dental arch). In the preferred embodiment, the dental articulator 50 is made of high strength plastic that is durable and designed not to fatigue or break. The dental articulator 50 is also preferably made of a royal blue color as this color contrasts well with the most popular lab stones that are typically used with dental articulators. Alternatively, the dental articulator 50 may be made of any other contrasting color including but not limited to any variations of blue such as dark blue, gray, or any other suitable contrasting color known to one skilled in the art.

The dental articulator 50 comprises a maxillary tray support member 52, a mandibular tray support member 54, and a hinge 56. In the preferred embodiment the maxillary tray support member 52 and the mandibular tray support member 54 are a mirror image of and/or identical to one another.

Each tray support member has a support surface 58 and a side wall 60. The support surface 58 has a front side 62 and a back side 64. In the preferred embodiment, the front side 62 of the support surface 58 is flat and provides a smooth surface area. The sides wall 60 extends outwardly from the periphery of the support surface 58 and at a perpendicular angle to form a recessed area 66 along the back side 64 of the support surface 58. Also, as discussed in further detail below, an arcing wall 74 extends outwardly from the back side 64 of the support surface 58 within the recessed area 66.

Situated within the support surface 58 of the maxillary tray support member 52 are a first set of a plurality of pin holes 68 and a second set of a plurality of pin holes 70. In the preferred embodiment, the first set of the plurality of pin holes 68 and the second set of the plurality of pin holes 70 are arranged in two identical arcing rows adjacent to one another and forming a single arcing row of a pair of adjacent pin holes 72. As depicted in a non-limiting example, there are illustrated twenty-seven (27) of the first set of the plurality of pin holes 68 and twenty-seven (27) of the second set of the plurality of pin holes 70. Preferably, one pin hole from the first set of plurality of pin holes 68 corresponds with an adjacent pin hole from the second set of plurality of pin holes 70 for forming the pair of adjacent pin holes 72.

Alternatively, the number of the first set of the plurality of pin holes 68 and the second set of the plurality of pin holes 70 may be more or less, as desired, provided that there is a corresponding pin hole 68 for each pin hole 70 for forming the pair of adjacent pin holes. As described later in the specification, the pair of adjacent pin holes will be used to accommodate the bi-pin design as illustrated in FIGS. 18-20 or any other type of acceptable bi-pin design known to one skilled in the art.

In another alternate embodiment, it is contemplated that there is either the first set of the plurality of pin holes 68 or the second set of the plurality of pin holes 70. In this alternate embodiment, a single pin design can be used for the appropriate pin holes alleviating the necessity of a second row of pin holes.

From each of the first set of plurality of pin holes 68, a passageway 76 extends through the support surface 58 to the back side 64 and partially into or completely through the arcing wall 74. The passageways 76 created in the arcing wall 74 forms a first arcing row on the back side 64 that is identical to the arcing row formed on the front side 62 from the first set of plurality of pin holes 68. In this manner, there exists a passageway 76 for each of the first set of plurality of pin holes 68. In the preferred embodiment, the passageway 76 extends in a straight line perpendicular to the support surface 58 and tapers inwardly from a first diameter 78 located at the front side 62 to a second diameter 80 located at the end of the passageway 76 within the arcing wall 74. As the passageway 76 provides a uniform inward taper and a continuous circular cross-section, the second diameter 80 is smaller than the first diameter 78. The purpose of the tapering design is to be releasably engageable with the pin used with the dental articulator 50 and to facilitate a more secure frictional engagement with the pin. Alternatively, it is contemplated that the passageway 76 may not taper but rather extend in a straight line perpendicular to the support surface 58 with the diameter of the passageway 76 being substantially the same from the front side 62 to the end of the passageway 76 within the arcing wall 74.

Likewise, from each of the second set of plurality of pin holes 70, a passageway 82 extends through the support surface 58 to the back side 64 and partially into or completely through the arcing wall 74. The passageways 82 created in the arcing wall 74 forms a second arcing row on the back side 64 that is identical to the arcing row formed on the front side 62 from the second set of plurality of pin holes 70. In this manner, there exists a passageway 82 for each of the second set of plurality of pin holes 70. In the preferred embodiment the passageway 82 extends in a straight line perpendicular to the support surface 58 with the diameter of the passageway 82 being substantially the same from the front side 62 to the end of the passageway 82 within the arcing wall 74.

Extending outwardly from each of the maxillary tray support member 52 and mandibular tray support member 54 are finger tabs 84. The finger tabs 84 provide a gripping means for the dental articulator 50 to be easily moved between the closed position as illustrated in FIG. 1 and the open position as illustrated in FIG. 2.

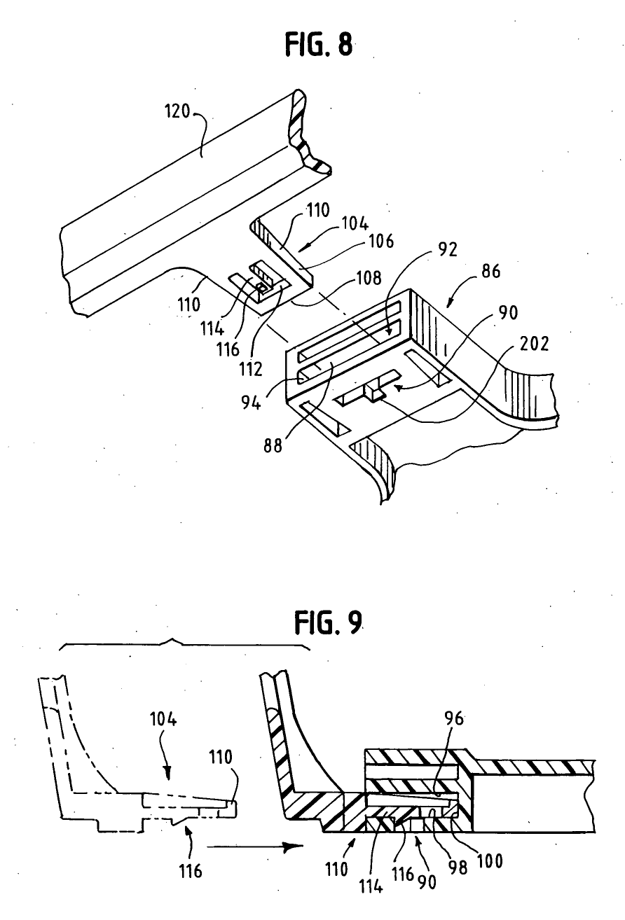

Situated at the corresponding ends of both the maxillary tray support member 52 and the mandibular tray support member 54 is a locking member 86. As more clearly illustrated in FIGS. 8 and 9, the locking member 86 comprises a chamber 88. In the preferred embodiment, the chamber 88 is rectangular in shape having an opening 92, interior opposed side walls 94, a top wall 96, a bottom wall 98, and a back wall 100 that form an enclosure within the chamber 88.

Within the enclosure formed in the chamber 88, the bottom wall 98 is provided with a notch 90 which also contains a cutout 102 (also identified as 202 in FIG. 8). The interior side walls 94 of the enclosure are designed to taper inwardly from the opening 92 of the chamber 88 to the back wall 100 of the chamber 88. In the preferred embodiment, the combination of the chamber 88, using the interior side walls 94, and the notch 90 coact to lockingly engage each of the maxillary tray support member 52 and mandibular tray support member 54 to the hinge 56.

To accomplish this locking engagement, the hinge 56 is provided with a key 104 (FIGS. 8 and 9). The key 104 comprises a shaft 106 having a front end 108 and shaft sides 110. The shaft sides 110 taper inwardly from the hinge 56 to the front end 108 of the shaft 106. In the preferred embodiment, the inward taper of the shaft sides 110 is substantially the same as the inward taper as provided by the interior side walls 94 of the chamber 88 to create the frictional engagement that will exist between the shaft 106 and the chamber 88.

The shaft 106 further contains a hole 112 through the center thereof. Attached to the shaft 106 and protruding to a position within the hole 112 is a finger projection 114. In the preferred embodiment, the entire finger projection 114 is located within the hole 112 and parallel to and/or in the same plane as the shaft 106. The finger projection 114 further provides a detent member 116 that extends outwardly from one side of the finger projection 114 perpendicular to the plane of the shaft 106. In the preferred embodiment, the extension of the detent member 116 from the finger projection 114 begins or starts flush with the exterior of the shaft 106 and protrudes a short distance beyond the exterior of the shaft 106.

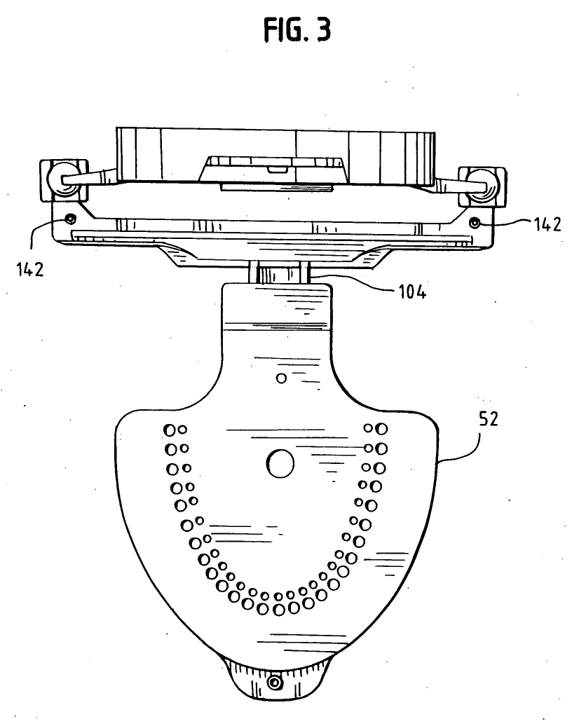

In use, the locking engagement of the hinge 56 to the maxillary tray support member 52 and mandibular tray support member 54 is created by inserting the key 104 into the locking member 86. In particular, the front end 108 of the shaft 106 is inserted into the opening 92 of the chamber 88. As the front end 108 of the shaft 106 continues into the chamber 88 toward the back wall 100, the shaft sides 110 will frictionally engage the interior side walls 94 of the chamber. The finger projection, situated between the opposed shaft sides 110 and within the hole 112, will proceed along with the shaft 106 into the chamber 88. As the detent member 116 protrudes from the shaft 106, the detent member 116 will engage the bottom wall 98 at the opening 92 of the chamber 88. As this occurs, the pressure exerted between the engagement of the detent member 116 with the chamber 88 will force the finger projection 114 to bend slightly within the hole 112 of the shaft 106 yielding to the chamber 88, thereby, permitting the detent member 116 to enter the chamber 88. As the shaft 106 proceeds into the chamber 88, the finger projection 114 will remain in the slightly yielding position and the detent member 116 will frictionally slide along the bottom wall 98 of the chamber 88. When the detent member 116 reaches the notch 90 in the bottom wall 98 the finger projection 114 will return to its original position thereby pushing the detent member 116 upward and into the cutout 102 of the notch 90. This will create a frictional engagement between the detent member 116 and the notch 90 and thereby retain or lock the key 104 within the locking member 86. This locking relationship is illustrated in FIGS. 3-7 and particularly FIG. 9. The opposite procedure is applied to remove the hinge 56 from either the maxillary tray support member 52 or the mandibular tray support member 54.

In this manner, the locking engagement of the hinge 56 to the tray support members 52 and 54 between the locking member 86 and the key 104 is created by, either individually or in combination, (a) the frictional or locking engagement between the detent member 116 of the shaft 106 and the notch 90 of the chamber 88; and/or (b) the frictional engagement of the tapering of the shaft sides 110 of the shaft 106 to the tapering of the interior side walls 94 of the chamber 88. As a result, this locking engagement provides a dental articulator 50 with a hinge 56 and tray support members 52 and 54 that are at a fixed angle and/or orientation with respect to one another. This locking engagement also inhibits the independent movement or pivoting of either component.

Referring back to FIGS. 1 and 2, the hinge 56 comprises an upper hinge arm 118, a lower hinge arm 120, and a hinge joint 122. The key 104, discussed infra, is attached to each of the upper hinge arm 118 and the lower hinge arm 120 of the hinge 56. In the preferred embodiment, the key 104 is integrally molded to each of the upper hinge arm 118 and the lower hinge arm 120 at approximately the lengthwise centerpoint of each arm.

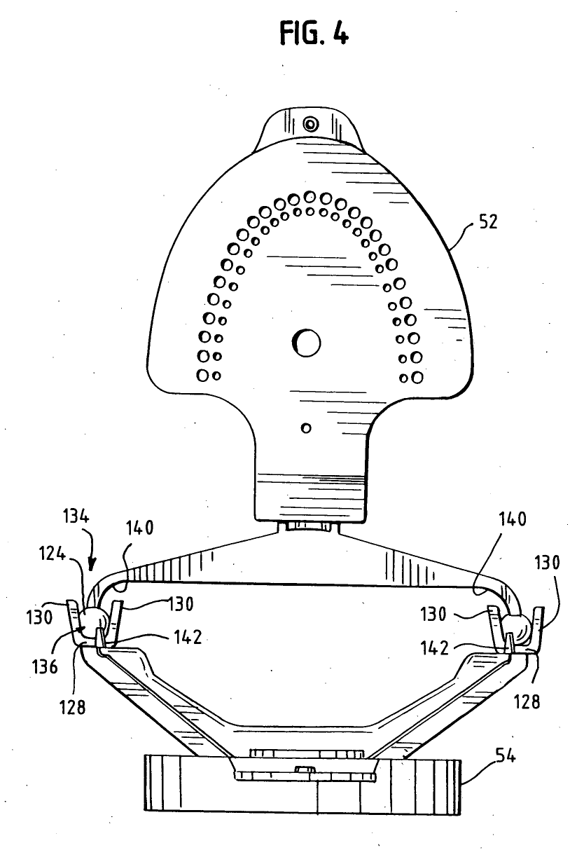

Situated at opposed ends of the upper hinge arm 118 are balls 124. The balls 124 are preferably circular in shape. Situated at opposed ends of the lower hinge arm 120 are sockets 126. In the preferred embodiment, the sockets 126 comprise a base 128 (see also FIG. 4), opposing sidewalls 130 (see also FIG. 4), and a hole 132. The opposing sidewalls 130 rigidly extend and taper outwardly from the base 128. In the preferred embodiment, the outward taper of the opposing sidewalls 130 is in a straight line and at an obtuse angle relative to the lengthwise plane of the base 128. In this manner, the sockets 126 extend upwardly from each end of the lower hinge arm 120 forming a U-shape with an opening 134 at the top. The hole 132 is disposed through the entire thickness of each sidewall 130 and is in substantially the same position in each of the opposing sidewalls 130 thereby forming a cavity 136 between them.

In the preferred embodiment, the hinge joint 122 is created from the releasably engageable mounting of the balls 124 from the ends of the upper hinge arm 118 with the sockets 126 from the corresponding ends of the lower hinge arm 120. This is accomplished by positioning the ball 124 within the opening 134 between the opposed sidewalls 130 of the socket 126. A recess 138 is provided in each sidewall 130 to initially receive the ball 124. In the preferred embodiment, the distance between the recesses 138 within the opposed sidewalls or of the opening 134 is substantially the same as the diameter of the ball 124. Upon pressure exerted between the engagement of the ball 124 with the tapering opposed sidewalls 130, the opposed sidewalls 130 will bend slightly outwardly yielding to the ball 124 and, thereby, permit the ball 124 to enter the cavity 136 and be positioned between the holes 132 in each of the sidewalls 130. Upon entering the cavity 136, the opposed sidewalls 130 return to their original position such that the opposing sidewalls 130 act as a stopping member for retaining and securing the ball 124 within the socket 126 and creating the hinge joint 122.

Once the hinge joint 122 is formed between the upper hinge arm 118 and the lower hinge arm 120, the maxillary tray support member 52 (i.e., attached to the upper hinge arm 118) can be rotated about each of the hinge joints 122 with respect to the mandibular tray support member 54 (i.e., attached to the lower hinge arm 120) such that the dental articulator 50 can be moved between its open and closed positions.

During the rotation of the maxillary tray support member 52 with respect to the mandibular tray support member 54, the upper hinge arm 118 is provided with a neck 140 (see also FIG. 4) adjacent to each ball 124 to prevent the upper hinge arm 118 from coming in contact with one of the sidewalls 130 and inhibiting the rotation.

A collar 142 is also provided on the lower hinge arm 120 adjacent to the hinge joint 122 for engaging the neck 140 of the upper hinge arm 118. In the preferred embodiment, the collar 142 acts as a stopping means for preventing the maxillary tray upport member 52 from any undesirable movement towards the mandibular tray support member 54 and for controlling the distance between them for enabling the dental articulator 50 to be set in the closed position.

Referring to FIG. 10, the alternate embodiment of Applicant's inventive dental articulator 50 is depicted. In this alternate embodiment of the dental articulator 50, the maxillary tray support member 52 and the mandibular tray support member 54 have been reduced from a full arch articulator to a half arch articulator as it is in the shape of a hall dental arch. All the remaining components of the tray support members remain the same in this alternate embodiment as that disclosed in the original embodiment.

The hinge 56, in this alternate embodiment, uses the exact same components and functions in the same manner as that disclosed in the original embodiment. The only differences in the hinge 56 are the following.

First, the body of the upper hinge arm 118 and the lower hinge arm 120 have been reduced from elongated members to short members. The main reason for this change is that reducing the size of the tray support members reduces the scope of the leverage required of the hinge 56 to accomplish the necessary articulation of the dental articulator 50. This enabled the hinge 56 to be reduced as illustrated. As a result, the upper hinge arm 118 provides the key 104 located at one end with the ball 124 located at the other end. Likewise, the lower hinge arm 120 provides the key 104 located at one end with the socket 126 located at the other end.

Second, the hinge joint 122 used to create the releasably engageable mounting of the upper hinge arm 118 with the lower hinge arm 120 is accomplished in a slightly different means. The ball 124 attached to the end of the upper hinge arm 118 is affixed with opposed ear extensions 144. Additionally, the socket 126 attached to the end of the lower hinge arm 120 provides a channel 146 situated in each of the sidewalls 130 at the opening 134 of the socket 126.

To create the hinge joint 122, the ball 124 is positioned within the opening 134 between the opposed sidewalls 130 of the socket 126 with each ear extension 144 of the ball 124 being received into each corresponding channels 146. In the preferred embodiment, the channel 146 begins with a diameter that is larger than the diameter of the ear extensions 144 to facilitate proper alignment and then tapers inwardly slightly to a diameter that is slightly less than the diameter of the ear extension 144. Upon pressure exerted between the engagement of the ear extensions 144 with the channel 146 in the opposed sidewalls 130, the opposed sidewalls 130 will bend slightly outwardly yielding to the ear extensions 144 and, thereby, permit the ball 124 to enter the cavity 136 and the ear extensions 144 to be received into the holes 132 in each of the sidewalls 130. Upon entering the holes 132, the opposed sidewalls 130 return to their original position such that the sidewalls 130 act as a stopping member for retaining and securing the ball 124 and ear extensions 144 within the socket 126 and creating the hinge joint 122.

Alternatively, the hinge joint for this alternate embodiment of the dental articulator 50 may be created using the exact same means as that disclosed in the original embodiment.

Lastly, the upper hinge arm 118 and the lower hinge arm 120 are each provided with a ledge 148 for providing a stopping means for preventing the undesirable movement of each member toward the other and for controlling the distance between them when the dental articulator 50 is to be set in the closed position.

Referring to FIGS. 18 through 20 illustrates Applicant's inventive bi-pin 150. The bi-pin 150 comprises a head 152 provided with anti-rotation members 158, a first leg 154, and a second leg 156. A base 160 connects the head 152, the first leg 154, and the second leg 156 together to form the bi-pin 150.

The first leg 154 is separated into four elongated walls 162, each sharing the same common end 164 and disposed perpendicular to one another relative to the common end 164. In the preferred embodiment, each of the elongated walls 162 are identical to one another. When in use, the first leg 154 is to be frictionally received into any one of the second set of plurality of pin holes 70.

The second leg 156 is separated into four members 166. Adjacent to the base 160, each of the four members 166 are separated from one another and taper inwardly toward their respective bottoms. In the preferred embodiment, the length of the second leg 156 is substantially the same as the length of the first leg 154. When in use, the second leg 156 is to be frictionally received into any one of the first set of plurality of pin holes 68 that corresponds with the second set of plurality of pin hole 70 to be occupied by the first leg 154. In this manner, the first leg 154 and second leg 156 correspond with and are frictionally received by any pair of adjacent pin holes 72.

The method for using the dental articulator 50 for making dental models comprises a number of steps. The dentist creates a negative impression of the patient's teeth, either mandibular, maxillary, posterior, or anterior. Typically, the negative impression is created in a mold tray. Positive impression or casting material, such as stone, is then poured into the negative impression of the mold tray. The bi-pin 150 is then inserted into the dental articulator using the first leg 154 and the second leg 1 56 as described above. Depending upon where the location of the negative impression of the patient's teeth has been taken, the bi-pin 150 is inserted into and frictionally retained in either the maxillary tray support member 52 or mandibular tray support member 54. The mold tray is then gently pressed against the appropriate tray support member with the head 152 of the bi-pin 150 being inserted into the positive impression material. When the positive impression material hardens it forms a dental model of the patient's teeth on one side with the bi-pins 150 being secured into the dental model on the other side. The anti-rotation members 158 of the head 152 are used to provide a more secure attachment to the impression material and prohibit rotation of the bi-pin 150 relative to the impression material. The dental model may then be removed from the dental articulator 50 by releasing the bi-pins 150 from the tray support member, after which, the dentist may perform restorative work on the appropriate teeth in the dental model and use the dental articulator to complete this work.

Thus, there has been provided a unique apparatus and method for making dental models. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the appended claims.

What is claimed is:

1. A dental articulator, comprising:
an upper tray support member;
a lower tray support member;
a hinge having an upper arm and a lower arm, the upper arm and the lower arm each having opposed ends;
means for lockingly engaging the upper tray support member to the upper arm of the hinge;
means for lockingly engaging the lower tray support member to the lower arm of the hinge; and
means for rotatably mounting the opposed ends of the upper arm and the lower arm to one another for enabling the dental articulator to transition between an open position and a closed position.

2. The dental articulator of claim 1 wherein the upper tray support member and the lower tray support member are in the shape of a full dental arch.

3. The dental articulator of claim 1 wherein the upper tray support member and the lower tray support member are in the shape of a half dental arch.

4. The dental articulator of claim 1 wherein the upper tray support member comprises a front side and a back side and having a proximal end and a distal end.

5. The dental articulator of claim 4 wherein an interior wall is formed on the back side of the upper tray support member.

6. The dental articulator of claim 5 wherein a first set of a plurality of pin holes is formed in the upper tray support member.

7. The dental articulator of claim 6 wherein each pin hole in the first set of the plurality, of pin holes extends from the front side, through the upper tray support member to the back side, and into the interior wall.

8. The dental articulator of claim 7 wherein each pin hole in the first set of the plurality of pin holes has a continuous cross-section that is circular in shape.

9. The dental articulator of claim 8 wherein each pin in the first set of the plurality of pin holes tapers inwardly from the front side of the upper tray support member and into the interior wall.

10. The dental articulator of claim 9 wherein each pin hole in the first set of the plurality of pin holes are positioned adjacent to one another for forming a continuous arc of pin holes in the upper tray support member.

11. The dental articulator of claim 10 wherein a second set of a plurality of pin holes is formed in the upper tray support member.

12. The dental articulator of claim 11 wherein each pin hole in the second set of the plurality of pin holes extends from the front side, through the upper tray support member to the back side, and into the interior wall.

13. The dental articulator of claim 12 wherein each pin hole in the second set of the plurality of pin holes has a continuous cross-section that is circular in shape.

14. The dental articulator of claim 13 wherein the diameter of each pin in the second set of the plurality of pin holes is substantially the same from the front side of the upper tray support member through and into the interior wall.

15. The dental articulator of claim 14 wherein each pin hole in the second set of the plurality of pin holes are positioned adjacent to one another for forming a continuous arc of pin holes in the upper tray support member.

16. The dental articulator of claim 15 wherein the continuous arc of the first set of the plurality of pin holes is adjacent to the continuous arc of the second set of the plurality of pin holes, each pin hole in the first set corresponding to an adjacent pin hole in the second set for forming a pair of pin holes.

17. The dental articulator of claim 16 wherein the lower tray support member is substantially identical to the upper tray support member.

18. The dental articulator of claim 4 wherein the means for lockingly engaging the upper tray support member to the upper arm of the hinge comprises a first locking means and a first key, the first locking means attached to the proximal end of the upper tray support member and the first key attached to the upper arm of the hinge between the opposed ends.

19. The dental articulator of claim 18 wherein the first locking means comprises an enclosure having an open end and a closed end formed by a continuous wall.

20. The dental articulator of claim 19 wherein the continuous wall of the enclosure tapers inwardly from the open end to the closed end.

21. The dental articulator of claim 20 and further comprising a notch in the continuous wall of the enclosure.

22. The dental articulator of claim 21 wherein the first key comprises a platorm member having a hole for forming a finger projection and a detent extending outwardly from the finger projection to a position beyond the exterior of the platform member.

23. The dental articulator of claim 22 wherein the platform member has exterior sides that taper inwardly as the platform member extends outwardly from the upper hinge arm.

24. The dental articulator of claim 23 wherein, upon insertion of the platform member through the opening and into the enclosure, the tapering of the continuous wall of the enclosure frictionally engages the tapering of the exterior sides of the platform member for lockingly engaging the upper tray support member to the upper arm of the hinge.

25. The dental articulator of claim 24 wherein the means for lockingly engaging the lower tray support member to the lower arm of the hinge is substantially identical to the means for lockingly engaging the upper tray support member to the upper arm of the hinge.

26. The dental articulator of claim 23 wherein, upon insertion of the platform member through the opening and into the enclosure, the finger projection is forced to temporarily bend to accommodate the opening in the enclosure until the detent reaches the notch, after which, the finger projection is released to return to its original position forcing the detent into the notch for lockingly engaging the upper tray support member to the upper arm of the hinge.

27. The dental articulator of claim 26 wherein the means for lockingly engaging the lower tray support member to the lower arm of the hinge is substantially identical to the means for lockingly engaging the upper tray support member to the upper arm of the hinge.

28. The dental articulator of claim 1 wherein the means for rotatably mounting the opposed ends of the upper arm to the lower arm of one another comprises a ball attached to the opposed ends of the upper arm and a socket attached to the opposed ends of the lower arm, the ball on each opposed end of the upper arm being frictionally received into the socket on the corresponding opposed end of the lower arm.

29. A dental articulator, comprising:
an upper tray support member having a proximal end and a distal end and defining a first plane between the proximal end and the distal end;
a lower tray support member having a proximal end and a distal end and defining a second plane between the proximal end and the distal end;
a hinge having an upper arm and a lower arm;
means for releasably locking the upper tray support member to the upper arm of the hinge in the first plane, the upper tray support member and the upper arm of the hinge being releasably locked in a fixed position and parallel orientation with respect to one another; and
means for releasably locking the lower tray support member to the lower arm of the hinge in the second plane, the lower tray support member and the lower arm of the hinge being releasably locked in a fixed position and parallel orientation with respect to one another.

30. The dental articulator of claim 29 wherein the means for releasably locking the upper tray support member to the upper arm of the hinge comprises a locking member and a key.

31. The dental articulator of claim 30 wherein the means for releasably locking the lower tray support member to the lower arm of the hinge is substantially the same as the means for releasably locking the upper tray support member to the upper arm.

32. The dental articulator of claim 29 wherein the upper arm is coupled to the lower arm by a rotatable hinge joint located at each of their respective ends.

33. The dental articulator of claim 32 wherein a ball is situated at each opposed end of the upper arm and a socket is situated at each opposed end of the lower arm.
